(19) United States
(12) Patent Application Publication
(10) Pub. No.: US 2023/0359050 A1
(43) Pub. Date: Nov. 9, 2023

(54) LOW RESIDUAL LAYER THICKNESS WAVEGUIDE WITH HIGH-INDEX COATING

(71) Applicant: GOOGLE LLC, Mountain View, CA (US)

(72) Inventors: Eliezer Glik, San Diego, CA (US); Shreyas Potnis, Kitchener (CA)

(21) Appl. No.: 18/141,674

(22) Filed: May 1, 2023

Related U.S. Application Data
(60) Provisional application No. 63/338,675, filed on May 5, 2022.

(51) Int. Cl. G02B 27/09; G02B 1/02; G02B 27/01

(52) U.S. Cl. CPC G02B 27/0944; G02B 1/02; G02B 27/0172; G02B 2027/0178

(57) ABSTRACT

To increase the field of view and/or the wavelengths of light (i.e., color bandwidth) transmitted by a waveguide without using high-index resin, some embodiments include a waveguide grating formed on a substrate that is imprinted with a relatively low-index resin and a conformal coating having a relatively high refractive index. In some embodiments, the substrate is imprinted with the resin using nano imprint lithography and the residual layer thickness of the resin layer is minimized. The conformal coating conforms to the geometry of the surface it coats with a substantially uniform thickness.

### CROSS-REFERENCE TO RELATED APPLICATION

The present application is a claims priority to U.S. Provisional Patent Application Ser. No. 63/338,675, entitled “LOW RESIDUAL LAYER THICKNESS WAVEGUIDE WITH HIGH-INDEX COATING” and filed on May 5, 2022, the entirety of which is incorporated by reference herein.

### BACKGROUND

Augmented reality (AR) display systems typically utilize an optical combiner that combines light from the real world and light from a display, which may represent computer-generated imagery or recorded imagery, for output toward at least one eye of a user. One common type of optical combiner is a waveguide (also commonly referred to as a “lightguide”) used to transfer light from a light source (e.g., a projector or micro-display) toward a user's eye, while being substantially transparent to incident light from the surrounding environment. Display light from the light source enters the waveguide through an input coupler (referred to herein as an incoupler (IC)) and is propagated through the waveguide via total internal reflection (TIR) or other internal propagation techniques, and then is output toward the user's eye via an output coupler (referred to herein as an outcoupler (OC)). The OC directs the light at an eye relief distance from the waveguide, forming an exit pupil within which a virtual image generated by the image source can be viewed within a field of view (FOV) by a user of the display device.

Some display devices use multiple waveguides to guide display light to a user's eye for applications such as augmented reality (AR) displays. For example, some conventional architectures for waveguides employ separate waveguides for each of the visible colors, separating blue, green, and red light into separate waveguides.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an AR near-eye display system utilizing a waveguide having a substrate with a first refractive index, a resin having a second refractive index imprinted on the substrate with a low residual layer thickness to form a waveguide grating, and a high-index conformal coating on the resin in accordance with implementations.

FIG. 2 is a diagram illustrating a waveguide embedded within the lens of FIG. 1 in accordance with some embodiments.

FIG. 3 illustrates a k-space diagram of the component wavelengths of display light traveling through the waveguide of FIG. 2 in accordance with some embodiments.

FIG. 4 illustrates a grating cross-section of a waveguide in accordance with some embodiments.

FIG. 5 illustrates a grating cross-section of a waveguide in accordance with some embodiments.

FIG. 6 illustrates a grating cross-section of a waveguide in accordance with some embodiments.

### DETAILED DESCRIPTION

Near-eye display systems such as eyewear display devices potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

Different wavelengths of light propagate through a waveguide via TIR at different angles. Light is only able to propagate through the waveguide via total internal reflection (TIR) at a limited number of discrete propagation angles (i.e., polar angles), such that all three colors of display light are able to successfully propagate through the waveguide to be output to the eye of a user for only a limited FOV. To propagate all three colors (red, blue, and green (RGB)) of the visible spectrum through a single waveguide to a relatively large FOV, some waveguide architectures employ high refractive index glass or other substrate material for both the waveguide and the waveguide gratings. An increase in FOV might also be associated with an increase in size to meet performance requirements.

The size of the field of view of an AR display system is limited by the k-space volume of the display system. The k-space diagram is a tool used in optical design to represent directions of light rays that propagate within a waveguide. Its horizontal and vertical axes represent the x and y (horizontal and vertical) components of ray directions relative to the user's eye. A point in k-space represents the direction cosines of a ray within the waveguide, scaled by the refractive index of the medium in which they propagate. The k-space volume can be increased by using higher refractive index materials for the waveguide, but such solutions are expensive. For a single waveguide, the incoupler grating to a diffractive waveguide diffracts light with different wavelengths to different regions of k-space. Red light is pushed the farthest in the k-space volume, and blue light is pushed the least. To carry all three RGB colors in a single waveguide to a single FOV, the refractive index of the waveguide materials must be increased (which impacts cost).

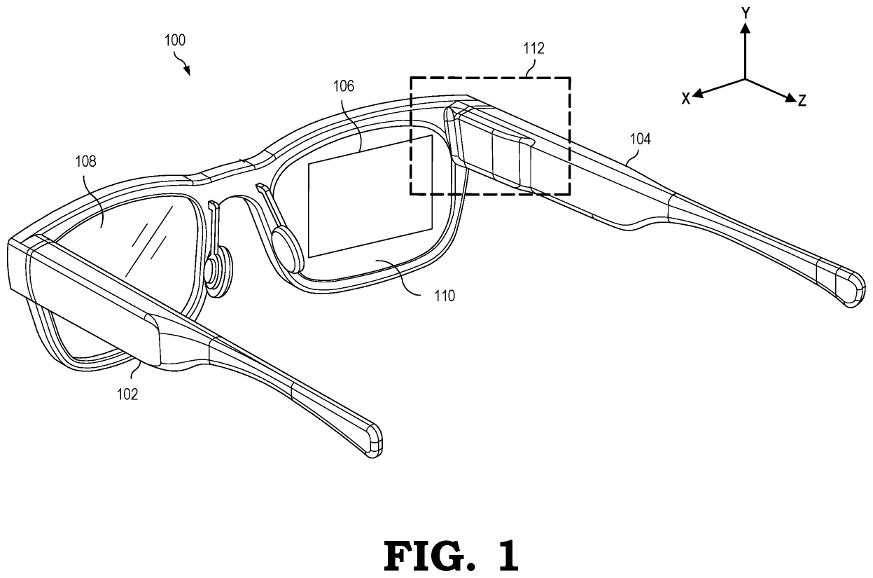

FIGS. 1-6 illustrate techniques for increasing the effective refractive index of a waveguide grating using a high-index conformal coating over a relatively low-index resin having a low residual layer thickness (RLT) to increase the FOV and/or color bandwidth of the waveguide. The waveguide includes a substrate such as glass or plastic with diffractive gratings that form one or more incouplers, one or more exit pupil expanders, and one or more outcouplers. The relatively low-index resin is imprinted on the substrate in a periodic structure to form the gratings. The diffraction efficiency of the grating is determined by the difference between the refractive index of air (1.0) and the refractive index of the grating. Typically, the refractive index of the resin and the refractive index of the substrate are matched to propagate a larger percentage of energy of display light into the substrate, where the light is guided by total internal reflection (TIR). Further, use of the relatively low-index resin typically negatively impacts diffraction efficiency because the difference between the index of air and the index of the resin is lower.

To offset the negative impacts of using a relatively low-index resin, some embodiments reduce the RLT of the resin. By reducing the RLT of the resin, a higher degree of mismatch between the refractive indices of the resin and the substrate can still result in a significant percentage of energy of the display light propagating into the substrate. Further, coating the relatively low-index resin with the high-index conformal coating increases the effective refractive index of the resin, and thereby increases the diffraction efficiency of the waveguide grating.

In some embodiments, the relatively low-index resin is imprinted on the substrate to form a grating having a binary periodic structure. In other embodiments, the grating is blazed or slanted. The grating has a periodic structure in one direction in some embodiments (i.e., a 1D grating) and has a periodic structure in two directions (i.e., a 2D grating) in other embodiments.

The refractive index of the resin is lower than the refractive index of both the substrate and the high-index conformal coating. In some embodiments, the refractive index of the high-index conformal coating is greater than 2.0. With the addition of the high-index conformal coating to the resin, the effective refractive index of the waveguide grating is higher than the refractive index of the resin. In some embodiments, the residual layer thickness of the resin that forms the waveguide grating is less than 130 nm and is imprinted on the substrate using nano imprint lithography. In some embodiments, the high-index conformal coating includes TiO2 and is applied using atomic layer deposition.

FIG. 1 illustrates an example eyewear display system 100 implementing a waveguide having a substrate with a first refractive index, a resin having a second refractive index imprinted on the substrate with a low RLT to form a waveguide grating, and a high-index conformal coating on the resin in accordance with implementations. The eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project RGB display light representative of images toward the eye of a user, such that the user perceives the projected display light as a sequence of images displayed in a primary field of view (FOV) area 106 at one or both of lens elements 108, 110 supported by the support structure 102.

In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102 further can include one or more batteries or other portable power sources for supplying power to the electrical components of the eyewear display system 100. In some embodiments, some or all of these components of the eyewear display system 100 are fully or partially contained within an inner volume of support structure 102, such as within the arm 104 in region 112 of the support structure 102. In the illustrated implementation, the eyewear display system 100 utilizes a spectacles or eyeglasses form factor. However, the eyewear display system 100 is not limited to this form factor and thus may have a different shape and appearance from the eyeglasses frame depicted in FIG. 1.

One or both of the lens elements 108, 110 are used by the eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide system, formed at least partially in the corresponding lens element. One or both of the lens elements 108, 110 thus includes at least a portion of a waveguide of the waveguide system that routes display light received by an incoupler grating (IC) (not shown in FIG. 1) of the waveguide to an outcoupler grating (OC) (not shown in FIG. 1) of the waveguide, which outputs the display light toward an eye of a user of the eyewear display system 100. Additionally, the waveguide employs an exit pupil expander grating (EPE) in the light path between the IC and OC (or in combination with the OC) in order to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

In some embodiments, the display light is emitted by a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the display light is emitted by a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the display light is emitted by a Liquid Crystal on Silicon (LCOS) display panel. In some embodiments, a display panel (referred to as a display) is configured to output display light (representing an image or portion of an image for display) into the waveguide system of the eyewear display system 100. The waveguide system expands the light and outputs the light toward the eye of the user via an outcoupler.

The display is communicatively coupled to a controller and a non-transitory processor-readable storage medium or memory storing processor-executable instructions and other data that, when executed by the controller, cause the controller to control the operation of the display. In some embodiments, the controller is communicatively coupled to one or more processors (not shown) that generate content to be displayed at the eyewear display system 100. The projector outputs light toward the FOV area 106 of the eyewear display system 100 via the waveguide system. In some embodiments, at least a portion of an outcoupler of the waveguide system overlaps the FOV area 106. The waveguide maintains a relatively large FOV area 106 and color bandwidth while using a relatively low-index resin to form the waveguide gratings by reducing the RLT of the resin and coating the relatively low-index resin with the high-index conformal coating.

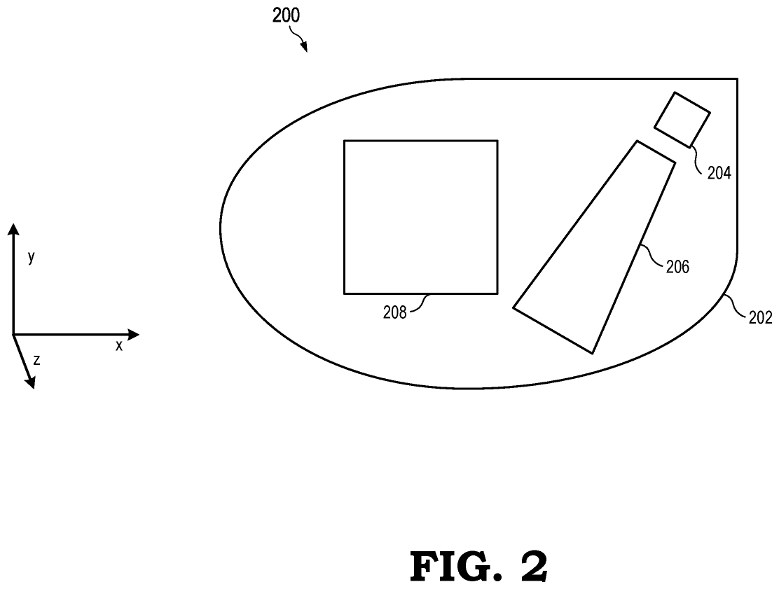

FIG. 2 shows a waveguide 200 within the rear view of a lens 202 carrying an incoupler 204, an exit pupil expander 206, and an outcoupler 208 of the waveguide 200 of in accordance with some embodiments. In the illustrated example, display light from a display (not shown) is guided through the same the incoupler 204, exit pupil expander 206, and outcoupler 208 of the waveguide system 200. The display light propagates into the waveguide system 200 via the incoupler 204 to the exit pupil expander 206, and then out of the waveguide 200 to a field of view.

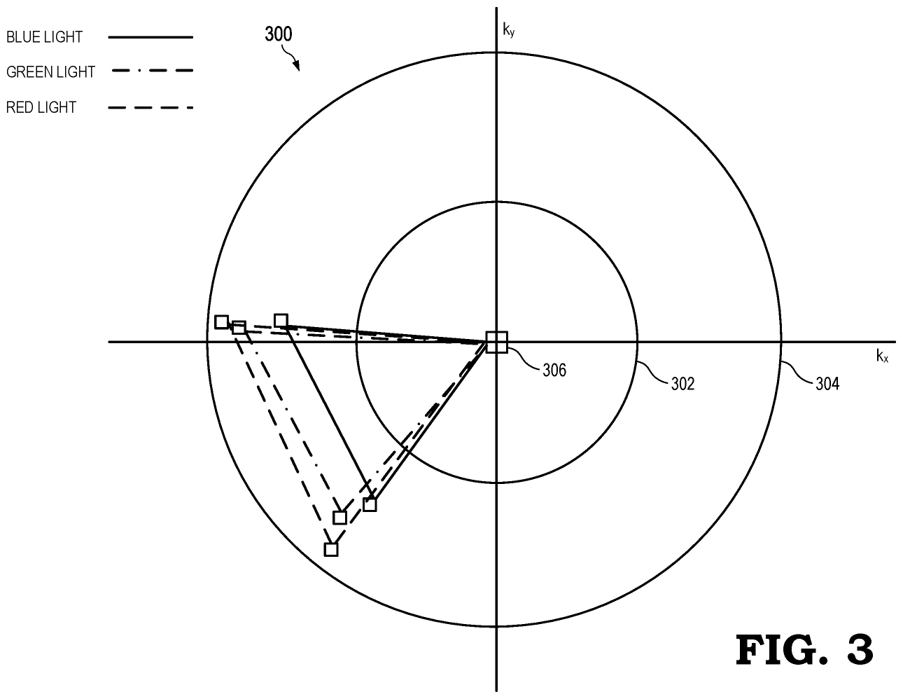

To propagate all three colors of the visible spectrum through a single waveguide, some waveguide architectures employ high-refractive index glass or other substrate material (e.g., having a refractive index n=2) for both the waveguide and the waveguide gratings. A k-space diagram such as shown in FIG. 3 illustrates the colors that are transmitted by a waveguide based on an angle limit and the index of refraction of the waveguide substrate and the waveguide incoupler and outcoupler gratings.

FIG. 3 illustrates a normalized k-space representation 300 of the component wavelengths of display light propagating through the waveguide 200. The k-space diagram is a tool used in optical design to represent directions of light rays that propagate within a waveguide. In the k-space representation 300, an inner refractive boundary 302 is depicted as a circle with radius of n=1, the refractive index associated with the external transmission medium (air). An outer refractive boundary 304 corresponds to an effective refractive index of the medium of the waveguide 200 of FIG. 2.

In the context of the k-space representation 300, for RGB display light to be successfully and accurately directed to an eye of a user via a waveguide (such as waveguide 200) with the indicated refractive index, each red, green, and blue component of that display light enters the waveguide system from an external position 306, which is included in the space depicted within inner refractive boundary 302. The color components are directed along one or more paths within the waveguide via total internal reflection (TIR) (light that undergoes TIR within the waveguide resides in the space depicted between inner refractive boundary 302 and outer refractive boundary 304) and are then redirected to exit the waveguide (and thereby return to the external space within inner refractive boundary 302 within which light does not undergo TIR). Display light components represented between the inner refractive boundary 302 and outer refractive boundary 304 are propagated to the user via the waveguide. Any display light components represented outside the outer refractive boundary 304 (of which there are none in the k-space representation 300) are non-propagating and cannot exist.

Initially, display light entering the waveguide at the incoupler (e.g., incoupler 204) forms an image that is centered at or around the origin of the k-space representation 300. The image is initially disposed at a first position 306 with respect to k-space. Upon redirection of the display light by the incoupler 204, the image is shifted in k-space to a second position, corresponding to a shift in the negative k_{y} and kₓ dimensions. Upon redirection of the display light by the exit pupil expander (e.g., exit pupil expander 206), the image is shifted in k-space to a third position, corresponding to a shift in the positive k_{y} dimension and the negative kₓ dimension. Upon redirection of the display light by the outcoupler (e.g., outcoupler 208), the image is shifted in k-space back to the first position 306, corresponding to a shift in the positive kₓ dimension. In the present example, it is assumed that the angle at which the display light enters the waveguide system via the incoupler 204 is the same as or substantially the same as (e.g., within 5% of) the angle at which the display light exits the waveguide via the outcoupler 208.

Thus, the inner circle 302 of the k-space diagram 300 is bound by the angle limit and the outside boundary circle 304 is the index of refraction of the waveguide substrate and a resin imprinted on the waveguide substrate to form a grating. Conventionally, the index of the grating (i.e., the resin) and the index of the substrate (e.g., glass) are matched to reduce the Fresnel reflections between the grating and the glass.

By reducing the residual layer thickness (RLT) of the resin that forms the grating on the substrate, a larger mismatch of refractive indices of the resin and the substrate can still result in a substantial portion of the energy of display light propagating through the substrate, because the light impinging on the grating is less affected by the resin and is impacted only by the refractive index of the substrate. In addition, the combination of the grating index and the glass index is the supporting effective index and, in the k-space diagram, is represented by the size of the outside circle 304. Thus, as illustrated in FIG. 3, a waveguide to propagate all three colors or a large field of view (FOV) is formed using a glass or substrate having a refractive index of 2.0 that is imprinted with a resin having a refractive index of 2.0. However, such a high-index glass is relatively expensive and heavy. In addition, such high-index resins are not readily available and have adhesion issues that make nano imprint lithography (NIL) replication and other surface relief grating (SRG) processing difficult and expensive. In addition, such a high-index glass cannot utilize other diffractive technologies that use a refractive index of n=1.5, such as Bragg and polarization Bragg.

To increase the field of view and/or the wavelengths of light (i.e., color bandwidth) transmitted by the waveguide without using high-index resin, some embodiments include a waveguide grating formed on a high-index substrate that is imprinted with a relatively low-index resin (e.g., having a refractive index n=1.5) and a conformal coating having a relatively high refractive index (e.g., having a refractive index n=2.2). In some embodiments, the substrate is imprinted with the resin using NIL. The conformal coating conforms to the geometry of the surface it coats with a substantially uniform thickness. In some embodiments, the conformal coating is TiO2. In some embodiments, the conformal coating is added to the low-index resin using atomic layer deposition (ALD). The high-index conformal coating increases the effective index of the grating to a higher index (e.g., n=2.0) depending on the ALD thickness.

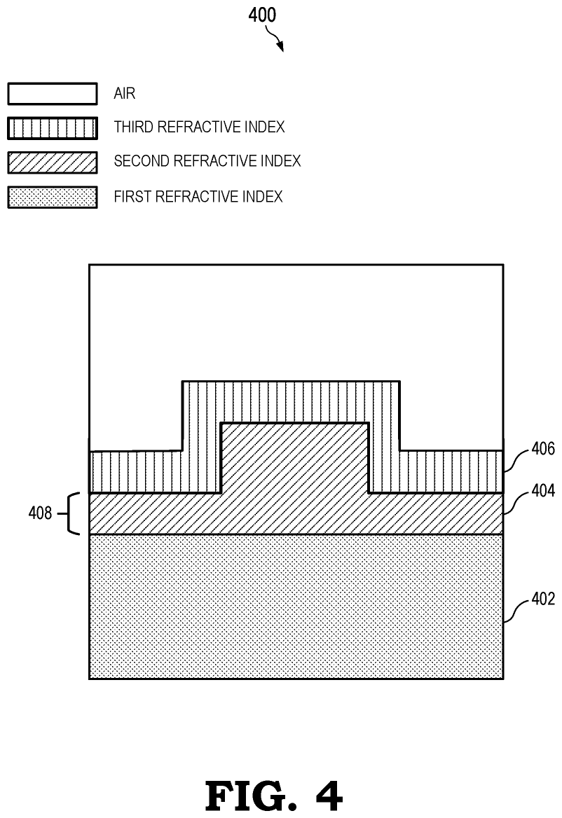

FIG. 4 illustrates an embodiment of a waveguide grating 400. The waveguide grating 400 includes a substrate 402, a resin 404, and a conformal coating 406. In some embodiments, the substrate 402 is glass or plastic having a first refractive index such as n=2.0. The substrate 402 is imprinted with the resin 404 to form the grating. In some embodiments, the resin 404 is imprinted on the substrate 402 by NIL. The resin 404 has a second refractive index and an RLT 408. For example, in some embodiments, the low-index resin has a refractive index of n=1.5 and an RLT 408 that is less than 120 nm (e.g., 50 nm). Although the difference between the first refractive index of the substrate 402 and the second refractive index of the resin 404 is relatively large, the low RLT 408 mitigates the effects of the mismatch in refractive indices and enables a relatively large percentage of energy of display light incident on the waveguide grating 400 to propagate into the waveguide. In some embodiments, after the resin 404 is imprinted onto the substrate 402 using NIL and the conformal coating 406 is added, the resin layer is removed, leaving only the high-index conformal coating 406.

The resin 404 is coated with a conformal coating 406 having a third refractive index that is higher than the second refractive index of the resin 404. In the illustrated example, the layer of resin 404 includes a bump that forms a binary 1D grating. The conformal coating coats the resin 404 layer by following the geometry of the resin layer with a substantially uniform thickness. In some embodiments, the conformal coating has a refractive index of n=2.2.

The addition of the high-index conformal coating increases the effective refractive index of the grating such that a lower-index resin can be used while still supporting transmission of red, green, and blue (RGB) wavelengths and/or a large field of view for the waveguide. In some embodiments, the respective refractive indices of the conformal coating 406 and the resin 404 depend on the thickness of the resin layer. For example, in some embodiments a thinner resin layer (e.g., 20-40 nm or even 0-20 nm) is used with a lower-index conformal coating 406, or a lower thickness coating 406, whereas a thicker resin layer (e.g., 1.2 um) is used with a higher-index conformal coating 406 and a higher-index resin 404, such as n=1.9.

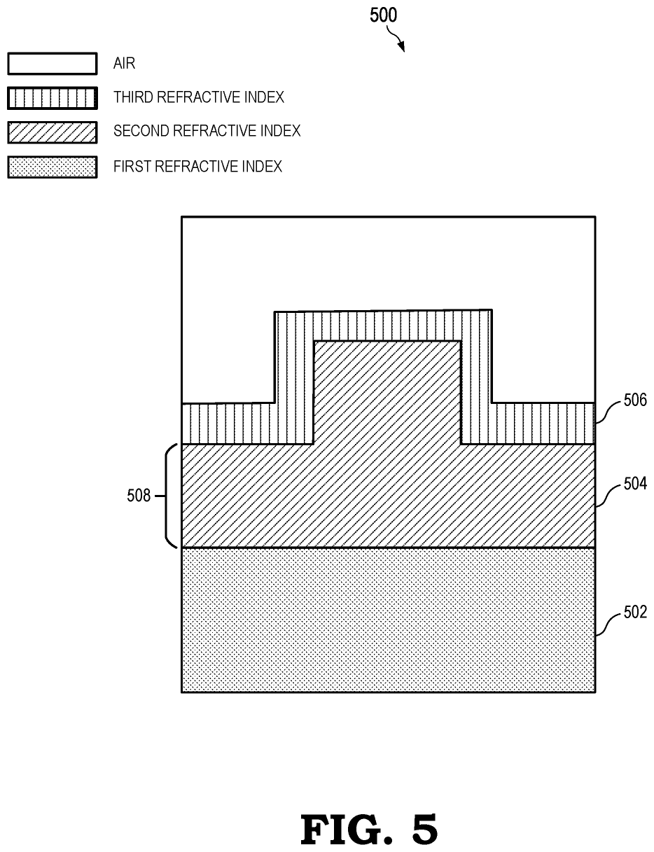

FIG. 5 illustrates an embodiment of a waveguide grating 500 having a substrate 502 with a first refractive index, a resin layer 504 with a second refractive index, and a conformal coating 506 with a third refractive index. In the illustrated example, the resin layer 504 has an RLT 508 that is thicker than the RLT 408 illustrated in FIG. 4. For example, in some embodiments, the RLT 508 is 120 nm. Because the RLT 508 is thicker, the refractive index of the substrate 502 and the refractive index of the resin layer 504 are more closely matched than in the example of FIG. 4. For example, if the RLT 508 is 150 nm, in some embodiments the refractive index of the substrate 502 is n=2.0 and the refractive index of the resin layer 504 is n=1.9. In other examples, the RLT 508 is 90 nm and the refractive indices of the substrate 502 and the resin layer 504 are n=2.0 and n=2.7, respectively.

To compensate for the higher thickness of the RLT 508, the conformal coating 506 has a refractive index that is higher than the refractive index of the conformal coating 406 illustrated in FIG. 4. For example, in some embodiments, the conformal coating 506 has a refractive index of 2.5. The high index of the conformal coating 506 increases the effective index of the resin layer 504, thus increasing the diffraction efficiency of the waveguide grating 500. In some embodiments, the thickness of the conformal coating 506 is determined by the desired diffraction efficiency of the waveguide grating 500. Some embodiments include more than one layer of conformal coating 506. Additionally, in some embodiments the waveguide grating 500 is encapsulated in a different material.

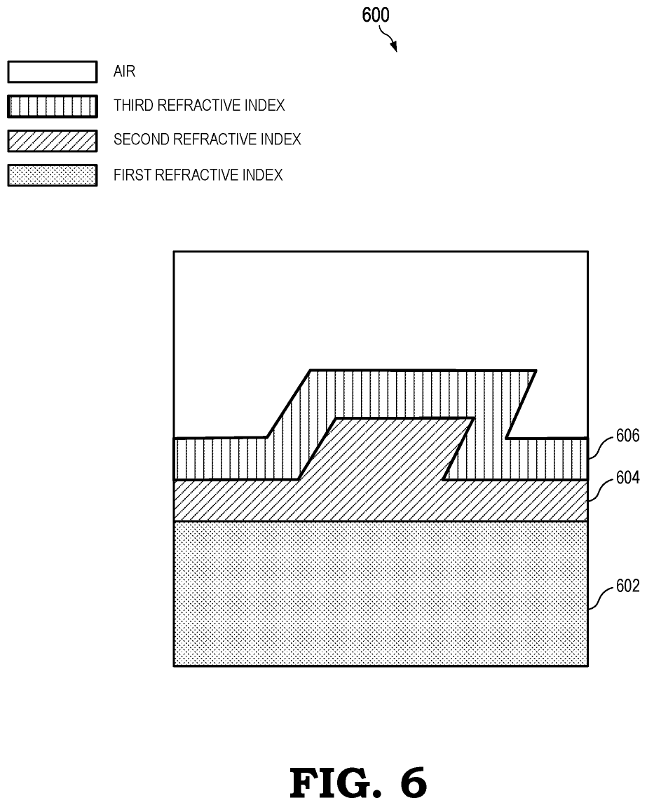

FIG. 6 illustrates an embodiment of a waveguide grating 600. Similar to the waveguide gratings 400 and 500 of FIGS. 4 and 5, the waveguide grating 600 includes a substrate 602 having a first refractive index, a resin layer 604 having a second refractive index, and a conformal coating 606 having a third refractive index. In contrast to the waveguide gratings 400 and 500, waveguide grating 600 has a slanted profile. Slanted gratings have high coupling efficiency in certain diffraction orders and benefit from a low RLT resin layer 604 and a high-index conformal coating 606, similar to the binary gratings illustrated in FIGS. 4 and 5. In other embodiments, the waveguide grating 600 has, e.g., a slanted, blazed, rulled, sinusoidal, or any other periodic structure profile. The waveguide grating 600 has a periodic structure in one direction in some embodiments (i.e., a 1D grating) and has a periodic structure in two directions (i.e., a 2D grating) in other embodiments.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
a substrate having a first refractive index;
a resin having a second refractive index imprinted on the substrate to form a waveguide grating; and
a conformal coating on the resin, the conformal coating having a third refractive index higher than the second refractive index, wherein the waveguide is configured to transmit light having at least one of a field of view and a color bandwidth that is greater than a field of view and a color bandwidth of a waveguide having the second refractive index without the conformal coating.

2. The waveguide of claim 1, wherein the second refractive index is less than the first refractive index.

3. The waveguide of claim 1, wherein the third refractive index is greater than 2.0.

4. The waveguide of claim 1, wherein an effective refractive index of the waveguide grating with the conformal coating is higher than the second refractive index.

5. The waveguide of claim 1, wherein the waveguide grating has a residual layer thickness less than 150 nm.

6. The waveguide of claim 1, wherein the conformal coating comprises TiO2.

7. The waveguide of claim 1, wherein the substrate is imprinted with the resin using nano imprint lithography.

8. The waveguide of claim 1, wherein the conformal coating is applied using atomic layer deposition.

9. A method comprising:
receiving light at a waveguide comprising a substrate having a first refractive index imprinted with a resin having a second refractive index to form a waveguide grating and a conformal coating on the resin, the conformal coating having a third refractive index higher than the second refractive index; and
transmitting through the waveguide light having at least one of a field of view and a color bandwidth that is greater than a field of view and a color bandwidth of a waveguide having the second refractive index without the conformal coating.

10. The method of claim 9, wherein the second refractive index is less than 2.0.

11. The method of claim 9, wherein the third refractive index is greater than 2.0.

12. The method of claim 9, wherein an effective refractive index of the waveguide grating with the conformal coating is higher than the second refractive index.

13. The method of claim 9, wherein the waveguide grating has a residual layer thickness less than 150 nm.

14. The method of claim 9, wherein the conformal coating comprises TiO2.

15. The method of claim 9, wherein the substrate is imprinted with the resin using nano imprint lithography.

16. The method of claim 9, wherein the conformal coating is applied using atomic layer deposition.

17. An eyewear display system, comprising:
a waveguide comprising one or more gratings, wherein the one or more gratings comprise:
a substrate having a first refractive index;
a resin imprinted on the substrate, the resin having a second refractive index; and
a conformal coating on the resin, the conformal coating having a third refractive index higher than the second refractive index, wherein the waveguide is configured to transmit light having at least one of a field of view and a color bandwidth that is greater than a field of view and a color bandwidth of a waveguide having the second refractive index without the conformal coating.

18. The eyewear display system of claim 17, wherein an effective refractive index of the waveguide grating with the conformal coating is higher than the second refractive index.

19. The eyewear display system of claim 17, wherein the waveguide grating has a residual layer thickness less than 150 nm.

20. The eyewear display system of claim 17, wherein the conformal coating comprises TiO2.
